(19) United States
(12) Patent Application Publication
(10) Pub. No.: US 2026/0201682 A1
(43) Pub. Date: Jul. 16, 2026

(54) Ultrasonic Monitoring Device and System

(71) Applicants: David SCHECTER, New York, NY (US); Takanori IDOTA, Aichi (JP); Ari MORSE, New York, NY (US); Emilie WILLIAMS, New York, NY (US); LIXIL Corporation, Tokyo (JP)

(72) Inventors: David Schecter, New York, NY (US); Takanori Idota, Aichi (JP); Ari Morse, New York, NY (US); Emilie Williams, New York, NJ (US)

(73) Assignee: LIXIL Corporation, Tokyo (JP)

(21) Appl. No.: 19/134,901

(22) PCT Filed: Dec. 19, 2023
(86) PCT No.: PCT/US2023/084785

§ 371 Date: Jun. 2, 2025

Related U.S. Application Data
(60) Provisional application No. 63/434,515, filed on Dec. 22, 2022.
(60) Provisional application No. 63/522,899, filed on Jun. 23, 2023.

(51) Int. Cl. E03B 7/07; G01F 1/66

(52) U.S. Cl. CPC E03B 7/072; G01F 1/662

(57) ABSTRACT

A sensing assembly configured to monitor material flow in a conduit, the sensing assembly comprising an adjustment mechanism; a housing; and an ultrasonic sensor assembly, wherein the ultrasonic sensor assembly is at least partially positioned within the housing and comprises an ultrasonic sensor, the ultrasonic sensor is configured to couple a conduit, and the adjustment mechanism is configured to allow for coupling of the ultrasonic sensor to conduits having a variety of diameters. An adjustment mechanism may be configured to allow for fine adjustment of sensor-to-conduit coupling.

The disclosure is directed to an ultrasonic monitoring device and system, in particular for monitoring, measuring and detecting fluid flow, for instance water flow in a building.

### BACKGROUND

In an effort to conserve water and safeguard integrity of building structures, attempts have been made to develop systems and methods configured to monitor for and identify plumbing system leaks. Also desired are systems and methods configured to determine water use efficiency of various water-use devices and appliances in a home, for instance toilets, faucets, showers, dishwashers, etc. It would be desirable to have a sensing system which may be coupled to a single main incoming source water pipe for a residence or for a multi-residence building or office building to achieve this.

Residences and other buildings have incoming source water pipes having a wide variety of sizes and materials. Desired is a universal sensing system which may be easily and non-intrusively coupled to incoming water source pipes of different sizes and materials, and configured to monitor for and identify a leak in a home or building. Also desired is a universal sensing system configured to identify different water-use devices and appliances and to determine their water use efficiency.

### SUMMARY

Accordingly, disclosed is a sensing assembly configured to monitor material flow in a conduit, the sensing assembly comprising an adjustment mechanism; a housing; and an ultrasonic sensor assembly, wherein the ultrasonic sensor assembly is at least partially positioned within the housing and comprises an ultrasonic sensor, the ultrasonic sensor is configured to couple a conduit, and the adjustment mechanism is configured to allow for coupling of the ultrasonic sensor to conduits having a variety of diameters. An adjustment mechanism may also allow for fine adjustment of sensor-to-conduit coupling.

The sensing assembly may comprise a general C-claim type shape and require no tools for installation on a conduit. A housing and adjustment mechanism may be configured to properly align a conduit to the assembly, such that optimal ultrasonic signals may be obtained from the ultrasonic sensor. The ultrasonic sensor may comprise a first ultrasonic transducer coupled to a first upstream wedge and a second ultrasonic transducer coupled to a second downstream wedge, wherein the first wedge and the second wedge are configured to be in direct physical contact with a conduit through a wedge lateral contact surface. A wedge may comprise an engineering thermoplastic. Also subject of the disclosure are a wedge and an ultrasonic sensor as described herein.

A sensing assembly may be configured to recognize and report a system leak or malfunction. A sensing assembly may be configured to recognize and report use of individual water-use devices or appliances, for example a toilet, a shower, a faucet, a dishwasher, a washing machine, etc., from a plurality of devices or appliances. A sensing system may be configured to determine and report a water leak or failure of a specific (individual) water-use device or appliance. A sensing system may be configured to determine and report water-use efficiency of individual water-use device or appliance.

### BRIEF DESCRIPTION OF THE DRAWINGS

This disclosure is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A, FIG. 1B, and FIG. 1C provide views of a sensing assembly comprising an ultrasonic sensor assembly coupled to a conduit, according to some embodiments.

FIG. 1D and FIG. 1E provide cross-section views of a sensing assembly comprising an ultrasonic sensor assembly coupled to a conduit, according to some embodiments.

FIG. 1F, FIG. 1G, and FIG. 1H provide partial views of a sensing assembly having an ultrasonic sensor assembly coupled to a conduit, according to some embodiments.

FIG. 1I, FIG. 1J, and FIG. 1K provide views of a portion of an ultrasonic sensor assembly, according to some embodiments.

FIG. 1L shows an ultrasonic sensor assembly, according to an embodiment.

FIG. 2 shows a sensing assembly according to an embodiment.

FIG. 3 shows a sensing assembly according to an embodiment.

FIG. 4A, FIG. 4B, and FIG. 4C provide views of a sensing assembly having an ultrasonic sensor assembly coupled to a conduit, according to some embodiments.

FIG. 4D provides an exploded view of a sensing assembly, according to an embodiment.

FIG. 4E provides various views of a sensing assembly, according to some embodiments.

FIG. 4F provides views of a sensor assembly and of a wedge, according to some embodiments.

FIG. 5 and FIG. 6 illustrate wedges of a sensor assembly coupled to conduits of varying diameters, according to some embodiments.

FIG. 7A and FIG. 7B show sectional views of a sensing assembly, according to some embodiments.

FIG. 8A, FIG. 8B, FIG. 8C, FIG. 8D, FIG. 8E, FIG. 8F, FIG. 8G, FIG. 8H, FIG. 8I, and FIG. 8J show various views of a sensing assembly and sensing assembly components, according to some embodiments.

### DETAILED DESCRIPTION

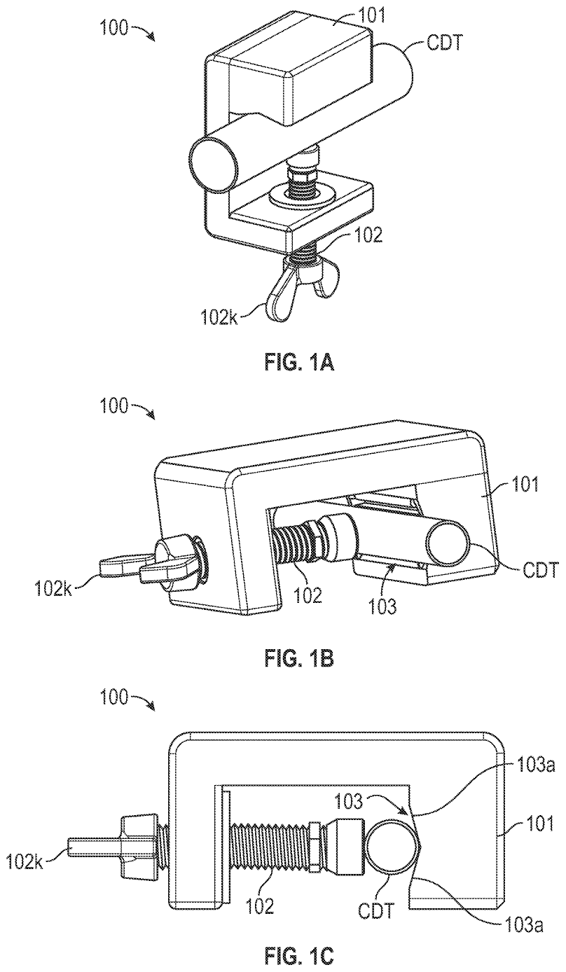

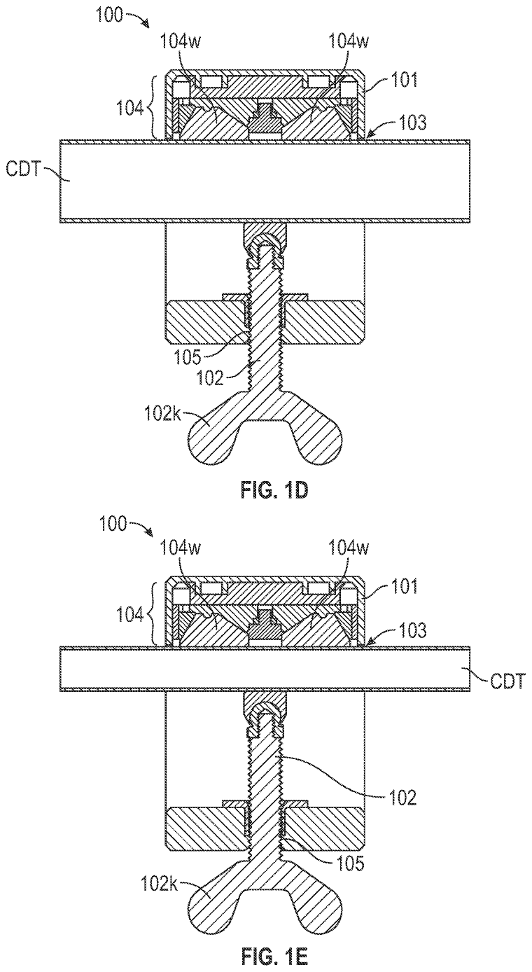

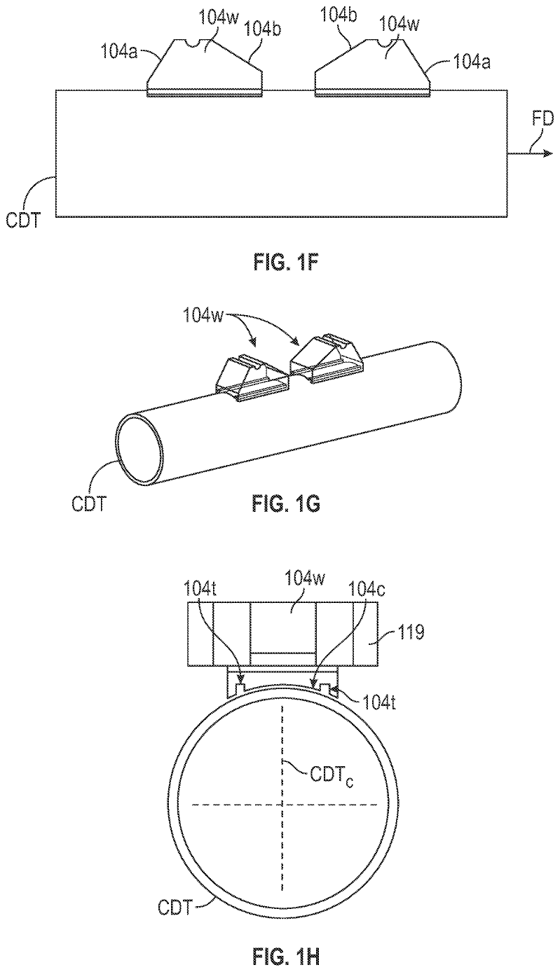

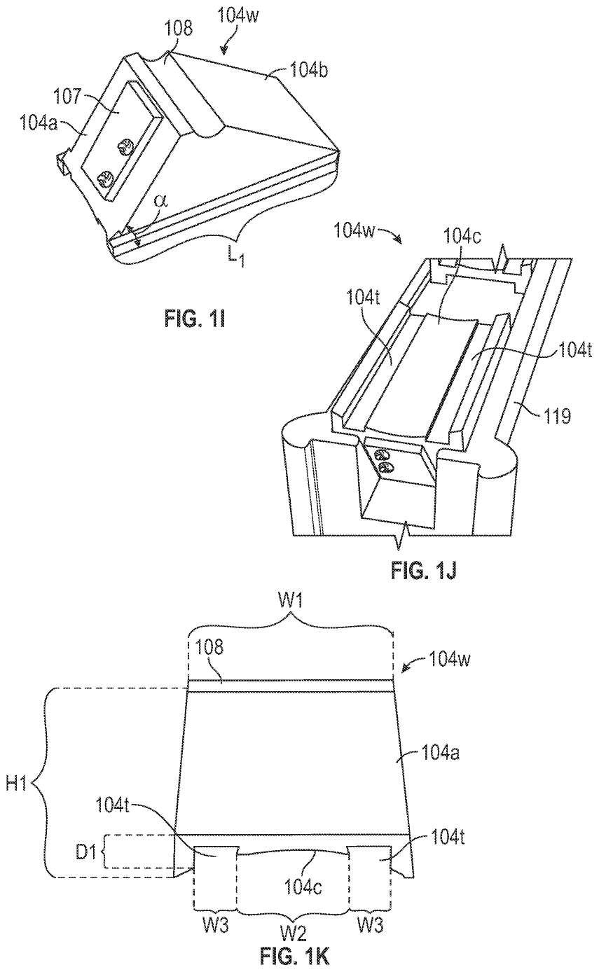

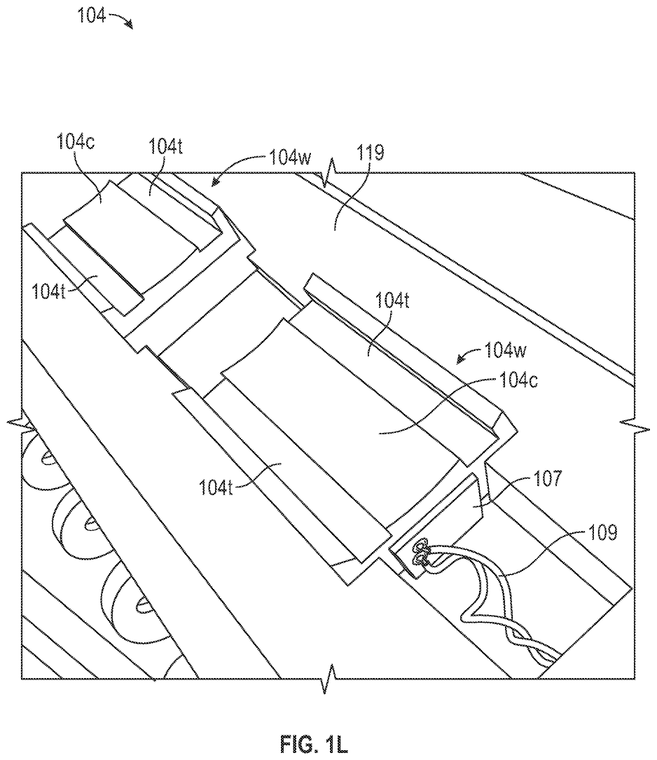

FIG. 1A shows sensing assembly 100, coupled to conduit CDT, according to an embodiment. Conduit CDT may be configured to have a material comprising one or more of a gas, a particulate, a liquid, a liquid suspension, a liquid solution, etc. flow through it. Sensing assembly 100 comprises a C-clamp shape and contains ultrasonic sensor assembly housing 101 and adjustable screw 102. Ultrasonic sensor housing 101 comprises an ultrasonic sensor assembly positioned therein (not visible), which is in electronic communication with a controller (not shown), and is configured to monitor flow in conduit CDT and to relay information to the controller. Adjustable screw 102 allows assembly 100 to be coupled to conduits having a variety of diameters. In an embodiment, assembly 100 may comprise a sensor (not shown) configured to recognize a position of screw 102 and relay the position information to a controller (not shown). The controller may be configured to determine if sensing assembly 100 is in an optimal position to monitor material flow through conduit CDT. The controller may be in electronic communication with indicator LED lights (not shown) or other display, in order to indicate if assembly 100 is in an optimal position, or if screw 102 should be tightened or loosened. Screw 102 is coupled to handle 102k for tightening or loosening. For example, an LED light indicator may show red for no signal, yellow for weak signal, and green for good (optimal) signal. In some embodiments, a controller may be configured to determine a conduit diameter from a sensed screw position. Adjustable sensing assembly 100 may be considered a “one-piece” assembly.

FIG. 1B and FIG. 1C provide further views of sensing assembly 100, according to some embodiments. Sensing assembly 100 may be positioned in a variety of different orientations, depending on a user's preference or space limitations. Further, no tools may be required for coupling sensing assembly 100 to conduit CDT. Ultrasonic sensor housing 101 comprises opening 103, containing an ultrasonic sensor assembly (not visible). Opening 103 is configured to provide for physical contact between conduit CDT and the ultrasonic sensor assembly. Angled edge 103a is positioned adjacent opening 103, and is configured to receive conduits of different sizes/diameters. In other embodiments, angled edge 103a may instead be a curved edge, or may instead be a rectangular-shaped cut-out. Angled edges 103a together form a well configured to receive conduit CDT.

FIG. 1D and FIG. 1E show cross-section views of sensing assembly 100, according to some embodiments. Assembly 100 of FIG. 1D is coupled to 1 inch diameter conduit CDT, and assembly 100 of FIG. 1E is coupled to one half inch diameter conduit CDT. Ultrasonic sensor housing 101 contains ultrasonic sensor assembly 104. Sensor assembly 104 comprises wedges 104w, which are in physical contact with conduit CDT. Sensing assembly 100 is coupled to adjustment screw 102 via threaded connection 105.

FIG. 1F, FIG. 1G, and FIG. 1H provide partial views of sensing assembly 100, according to some embodiments. Shown are conduit CDT coupled to and in physical contact with wedges 104w in a side view, perspective view, and other side view. Material is configured to flow in flow direction FD, so that a first wedge will be positioned upstream and a second wedge will be positioned downstream. The first wedge and the second wedge are symmetrical and interchangeable, so that sensing assembly 100 may be reversed, reversing the position of upstream and downstream wedges. Wedges 104w have curved lateral contact surface 104c, configured to be in physical contact with conduit CDT. Lateral contact surface 104c runs in an upstream/downstream direction of conduit CDT. Contact surface 104c is curved and configured to provide for a maximum surface area contact and energy transfer between conduit CDT and an ultrasonic sensor (not shown). Wedges 104w also comprise lateral troughs 104t, which run parallel to curved lateral surface 104c. Troughs 104t prevent an ultrasonic sensor (not shown) from detecting ultrasonic waves that are not aligned with conduit centerline CDTc. Prevention of detection of ultrasonic waves not aligned with a conduit centerline may help filter out noise and provide more reliable data. Sensor assembly 104 comprises wedges 104w positioned in wedge holder 119. In an embodiment, wedges 104w may comprise an engineering thermoplastic, for example a polysulfone.

FIG. 1I, FIG. 1J, and FIG. 1K show views of wedge 104w, according to some embodiments. Wedge 104w of FIG. 1I has piezo transducer 107 bonded to angled surface 104a. Wedge also comprises opposing angled surface 104b. In this embodiment, angle a is about 58°. Each wedge 104w of a pair will have an ultrasonic transducer coupled thereto. An ultrasonic sensor of the present description may refer to a pair of ultrasonic transducers. A first wedge will have a first ultrasonic transducer coupled to an upstream angled surface 104a, and a second wedge will have a second ultrasonic transducer coupled to a downstream angled surface 104a (see FIG. 1F). Wedge/transducer assemblies may be mirror images of each other and interchangeable. Curved contact surface 104c and parallel troughs 104t are shown in FIG. 1J, showing an underside of wedge 104w positioned in wedge holder 119. Wedge 104w of this embodiment comprises a height H1 of about 13 mm, a length L1 of about 26 mm, and a width W1 of about 13.4 mm. Troughs 104t have a width W3 of about 1.0 mm, and contact surface 104c has a width W2 of about 9.4 mm. Troughs 104t of this embodiment comprise a depth D1 of about 1.2 mm. Length L1 will essentially be the length of contact surface 104c and troughs 104t. Channel 108, positioned on an upper portion of wedge 104w, runs perpendicular to contact surface 104c and troughs 104t. Channel 108 may be configured to provide wedge 104w a degree of freedom to allow for sensor assembly 104 to align with conduit CDT.

FIG. 1L shows an underside view of ultrasonic sensor assembly 104, according to an embodiment. Shown are a pair of thermoplastic wedges 104w positioned in wedge holder 119, having contact surface 104c and parallel troughs 104t. Ultrasonic transducer 107 is electrically coupled to a controller (not shown) via wires 109.

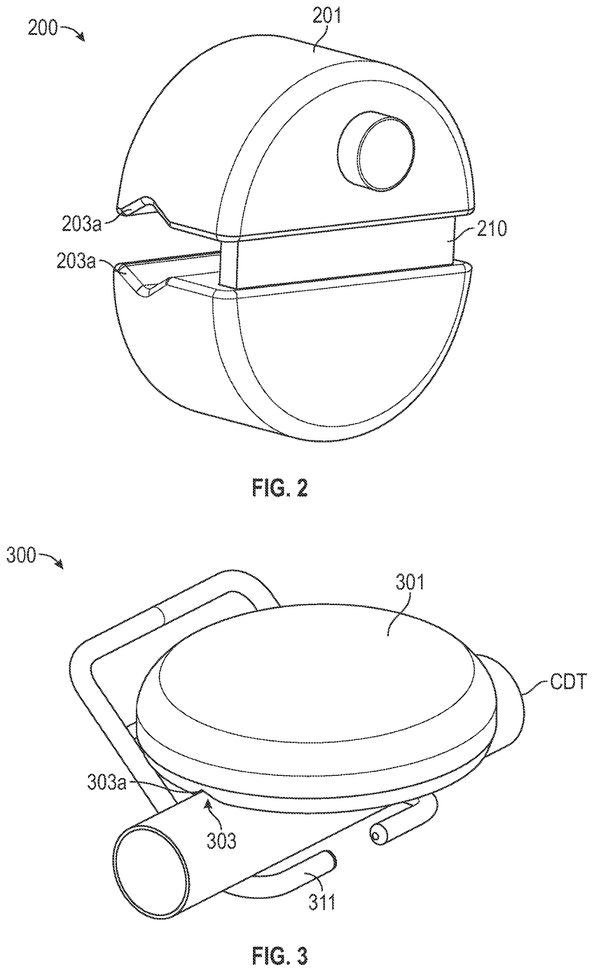

FIG. 2 shows sensing assembly 200, according to an embodiment. Assembly 200 comprises adjustable clamp/spring mechanism 210, configured to allow for conduits of varying diameters to be coupled to an ultrasonic sensor assembly through an opening adjacent angled edges 203a. An ultrasonic sensor assembly positioned in housing 201 is configured to be in direct physical contact with a conduit through the opening (not visible). Assembly 200 is a one-piece assembly, requiring no tools to couple to a conduit.

FIG. 3 shows sensing assembly 300, according to an embodiment. Assembly 300 is shown coupled to conduit CDT. Ultrasonic sensor housing 301 comprises opening 303 adjacent angled edge 303a. An opening will allow for an ultrasonic sensor assembly positioned in housing 301 to be in direct physical contact with conduit CDT. Assembly 300 comprises adjustable clamp/spring type mechanism 311. Assembly 300 is a one-piece assembly, requiring no tools to couple to a conduit.

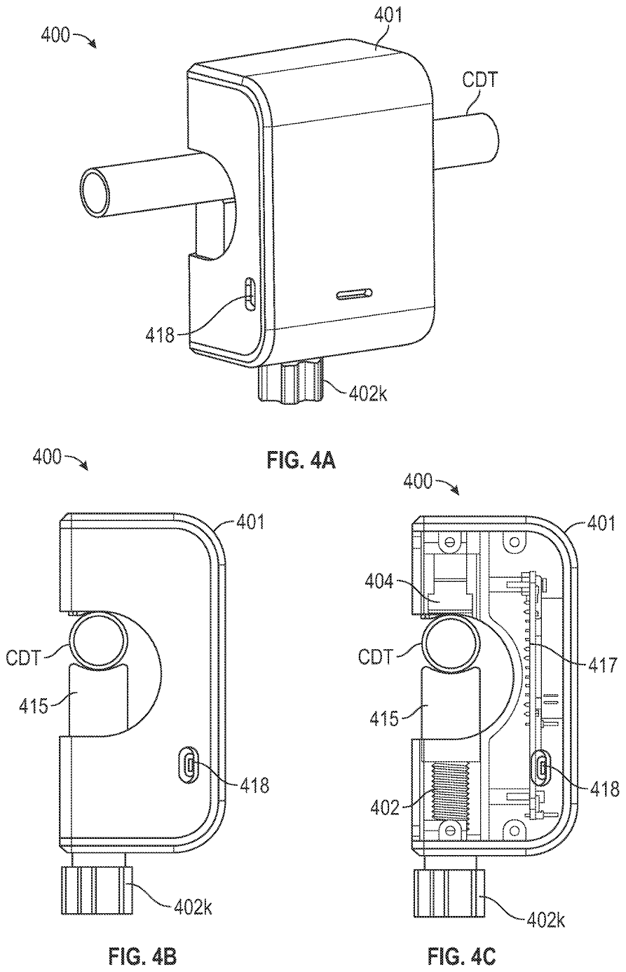

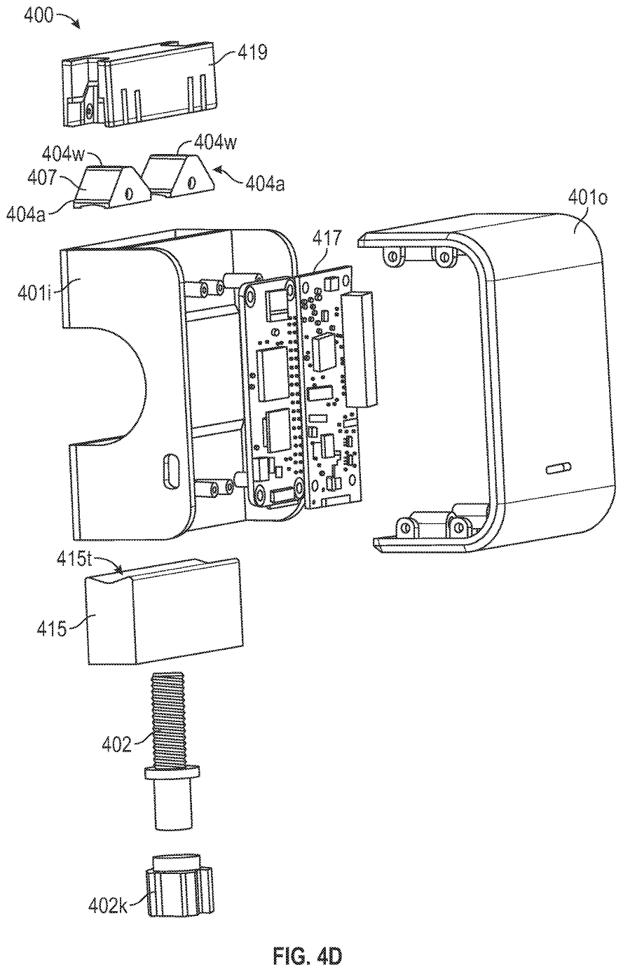

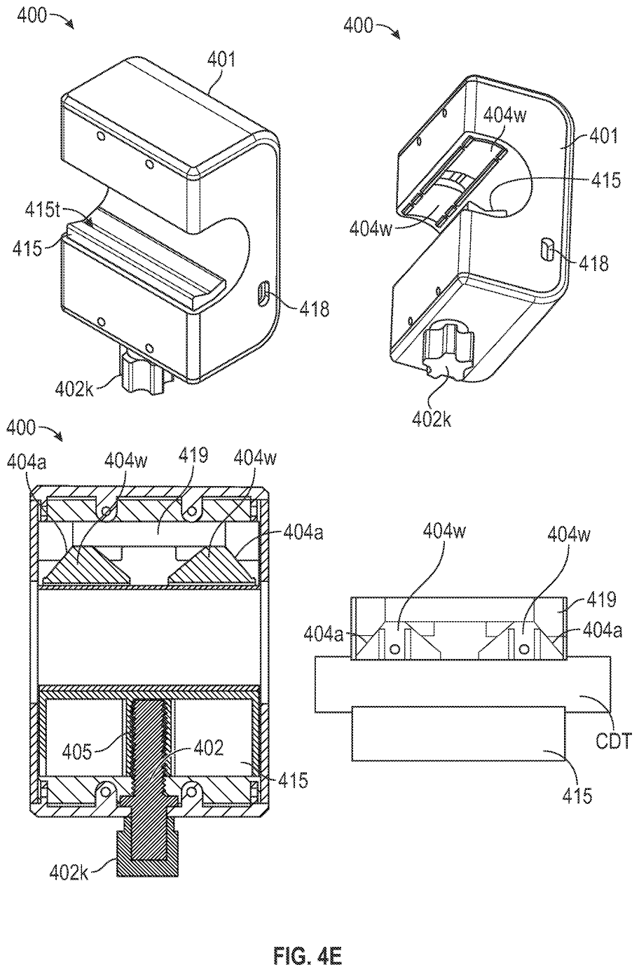

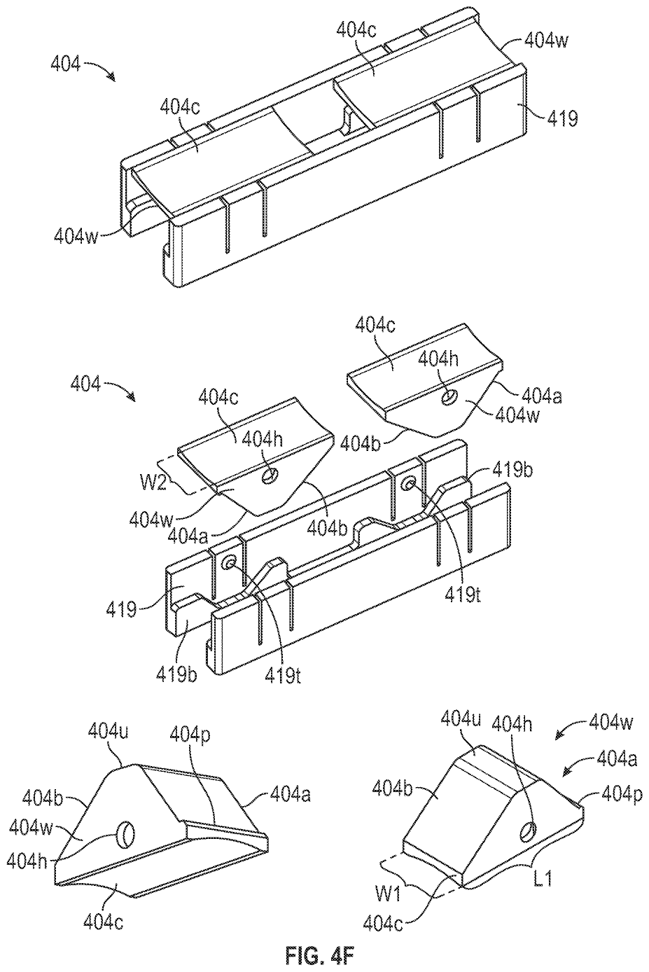

FIG. 4A, FIG. 4B, and FIG. 4C provide views of sensing assembly 400, coupled to conduit CDT, with FIG. 4C providing a see-through view, according to some embodiments. Assembly 400 comprises an overall C-clamp type shape. Housing 401 comprises ultrasonic sensor assembly 404 positioned therein. Knob 402k may be turned to move screw 402 in order to provide for optimal contact of conduit CDT with wedges (not visible) of sensor assembly 404. Turning screw 402 is configured to adjust a position of conduit cradle 415 which in turn is configured to optimize a position of conduit CDT relative to ultrasonic sensor assembly 404 to monitor material flow therethrough. Housing 401 comprises controller 417 positioned at an interior thereof, which is electrically coupled to ultrasonic sensor assembly 404. Sensor assembly 404 is configured to monitor material flow through conduit CDT and to relay information to controller 417. Controller 417 is also electrically coupled to LED indicator light 416 positioned at an exterior of housing 401. Controller 417 is configured to instruct LED indicator 416 to display a light, for example a green light, to indicate proper positioning of sensor assembly 404 on conduit CDT to monitor material flow therethrough. Cradle 415 and housing 401 are able to accommodate conduits having a variety of diameters. Housing 401 comprises power receptacle 418, configured to receive a wire to provide electric power to components including controller 417, LED indicator 416, and sensor assembly 404.

FIG. 4D provides an exploded view of sensing assembly 400, according to some embodiments. Shown are outer housing 401o, inner housing 401i, and controller 417, configured to be positioned at an interior of housing 401. Also shown are knob 402k, and screw 402, configured to couple to conduit cradle 415. Conduit cradle 415 comprises angled upper surface, or trench 415t, configured to receive a conduit and center it within housing 401 for proper placement at sensor assembly 404. Sensor assembly 404 comprises wedges 404w and holder 419. Wedges 404w are configured to be positioned in wedge holder 419 and held at a fixed position therein. Each wedge 404w comprises ultrasonic transducer 407 coupled to an angled surface thereof. An ultrasonic sensor of the present description may refer to a pair of ultrasonic transducers. Each ultrasonic transducer is configured to be electrically coupled to controller 417. A first wedge 404w has ultrasonic transducer 407 coupled to upstream angled surface 404a, and a second wedge 404w has an ultrasonic transducer 407 coupled to downstream angled surface 404a.

FIG. 4E provides various views of sensing assembly 400, according to some embodiments. Counterclockwise from top right, shown are a bottom perspective view of assembly 400, a top perspective view of assembly 400, a sectional view of assembly 400, and a partial view of assembly 400 coupled to conduit CDT. Shown are housing 401, power receptacle 418, cradle 415, cradle trench upper surface 415t, adjustment screw 402, adjustment knob 402k, sensor assembly 404, wedges 404w, wedge angled surfaces 404a, and holder 419. Also shown is threaded connection 405, coupling screw 402 to cradle 415.

FIG. 4F provides views of ultrasonic sensor assembly 404 and of wedge 404w, according to some embodiments. The top illustration shows sensor assembly 404 from an underside position, having wedges 404w positioned in wedge holder 419. The center illustration shows an exploded view of sensor assembly 404. Wedges have curved contact surface 404c, configured to provide for high surface area contact with a conduit. Wedge holder 419 comprises brackets 419b, configured to receive each wedge 404w. Wedge holder 419 also comprises two pairs of protrusions 419t (one of each pair is visible), configured to couple to blind holes or indentations 404h positioned on each side of each wedge 404w. Protrusion 419t/hole 404h couplings are configured to indicate proper attachment of wedges 404w to holder 419, and also to allow for a degree of rotational movement of wedges 404w during coupling to a conduit. A degree of rotational movement is configured to compensate for any conduit irregular shapes and to provide for good contact of wedges 404w with a conduit.

FIG. 4F bottom illustrations show a bottom perspective view and a top perspective view of a wedge 404w. Visible is angled surface 404a configured to receive an ultrasonic transducer, opposing angled surface 404b, blind hole/indentation 404h, and curved contact surface 404c. Upper flat surface 404u is configured to be seated in brackets 419b of holder 419. Wedge surface 404a comprises extending edge 404p configured to receive an edge of an ultrasonic sensor. Wedge 404w comprises a length L1 of about 24.5 mm, largest width W1 of about 12 mm, a largest height of about 11 mm, and curved contact surface 404c width W2 of about 10 mm. Edge 404p extends about 0.5 mm out from surface 404a. In an embodiment, contact surface 404c may comprise a “rubberized” or elastomeric coating configured to act as a surface contact promoter between surface 404c and a conduit. A surface contact promoter may improve surface-to-surface contact of surface 404c and a conduit surface and may improve ultrasonic signal strength and quality. For instance, any air gaps in a contact area may be eliminated.

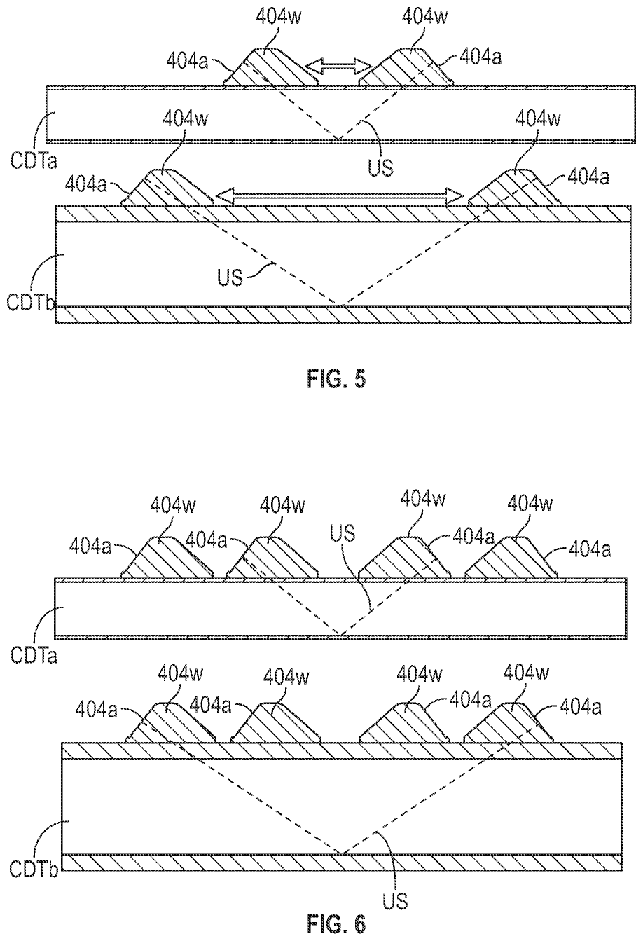

FIG. 5 and FIG. 6 show a portion of a sensor assembly coupled to conduits of varying diameters, according to some embodiments. FIG. 5 shows a pair of wedges 404w coupled to conduit CDTa having a first diameter (inner or outer) and to conduit CDTb having a larger second diameter. Each wedge 404w of a pair will have an ultrasonic transducer coupled to angled face 404a. An ultrasonic sensor may refer to a pair of ultrasonic transducers. A first ultrasonic transducer and a second ultrasonic transducer are configured to alternately send and receive an ultrasonic signal US through a first wedge of a pair, through a conduit, and through a second wedge of a pair. A controller is configured to ultimately receive digital data from an ultrasonic sensor. Conduits having varying diameters may require varying distances between a pair of wedges to provide an optimal ultrasonic signal US.

FIG. 5 illustrates a sensing assembly may be configured to automatically adjust a distance between a first wedge and a second wedge to a point at which a maximum signal US amplitude is obtained. A sensing assembly may comprise a motorized linear rail, threaded rod, etc. configured to automatically adjust a distance between wedges. An optimal US signal may be determined by a controller, and the controller may be configured to direct a motor to adjust a distance between wedges. In another embodiment, a vertical clamp feature, for example a clamp feature comprising a screw as shown in prior figures, may be mechanically coupled to a feature configured to adjust a perpendicular movement of one or both wedges of a pair along a conduit. As one adjusts a clamp feature, a distance between a first wedge and second wedge will adjust and an optimal position may be displayed by an indicator light.

FIG. 6 illustrates a sensing assembly comprising more than one pair of wedges and ultrasonic sensors. A controller may be configured to determine which pair of ultrasonic sensors to employ for monitoring flow through a conduit. For instance, in CDTa, it is determined that a first, inner pair of wedges 404w having ultrasonic transducers coupled thereto should be employed. For CDTb, it is determined that a second, outer pair of wedges 404w should be employed.

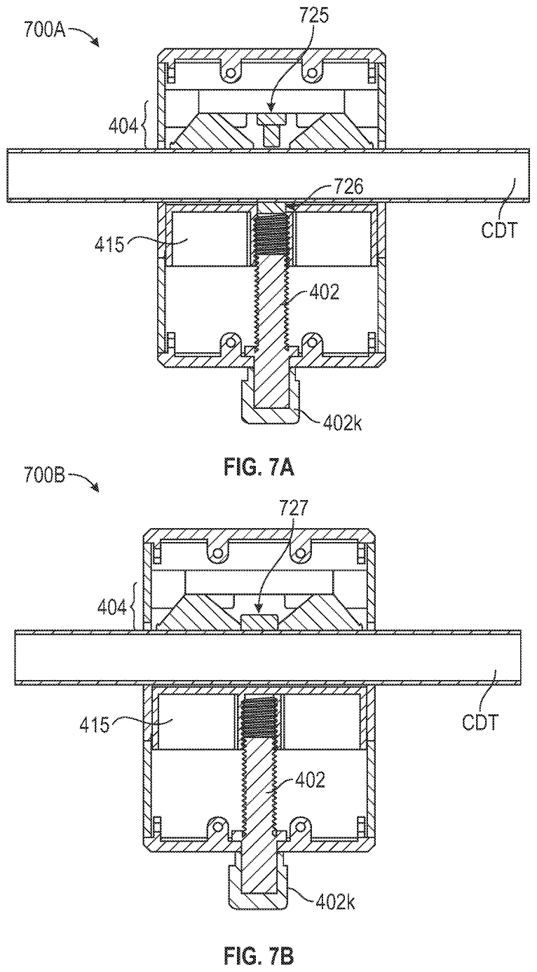

FIG. 7A and FIG. 7B provide sectional views of sensing assemblies 700A and 700B, respectively. Assemblies 700A and 700B are coupled to conduit CDT. Shown are ultrasonic sensor assembly 404, adjustment screw 402 and knob 402k, and conduit cradle 415.

Assembly 700A comprises additional sensors 725 and 726 configured to be positioned at conduit CDT. Sensors 725 and 726 may be configured to determine a diameter of conduit CDT and to relay this information to a controller. Sensors 725 and 726 may be configured to determine a position of conduit CDT in assembly 700A and to relay information to a controller regarding the position (optimal/not optimal). A controller may be configured to use conduit diameter information and/or conduit position to adjust a distance between wedges, or to inform a user that a position is optimal or not (via a display or indicator). Sensors 725 and 726 may be configured to provide data to a controller in concert or individually. Sensors 725 and 726 may be configured to provide data to a controller in concert with ultrasonic sensor assembly 404, or separately. Sensors 725 and 726 may comprise one or more inductive, capacitive, optical (infrared (IR), photoelectric), magnetic, ultrasonic, or rotary sensors.

Assembly 700B comprises temperature sensor 727 configured to be positioned at and to contact conduit CDT. Sensor 727 may be configured to relay conduit CDT temperature to a controller. A controller may be configured to compare and relate material flow rate information gathered from ultrasonic sensor assembly 404 to temperature received from sensor 727. This may provide for more accurate flow rate information. A temperature sensor may comprise a thermocouple, a probe, and or a thermistor. In another embodiment, a temperature sensor need not be in contact with conduit CDT, for example a temperature sensor may comprise a thermopile, an IR sensor, etc.

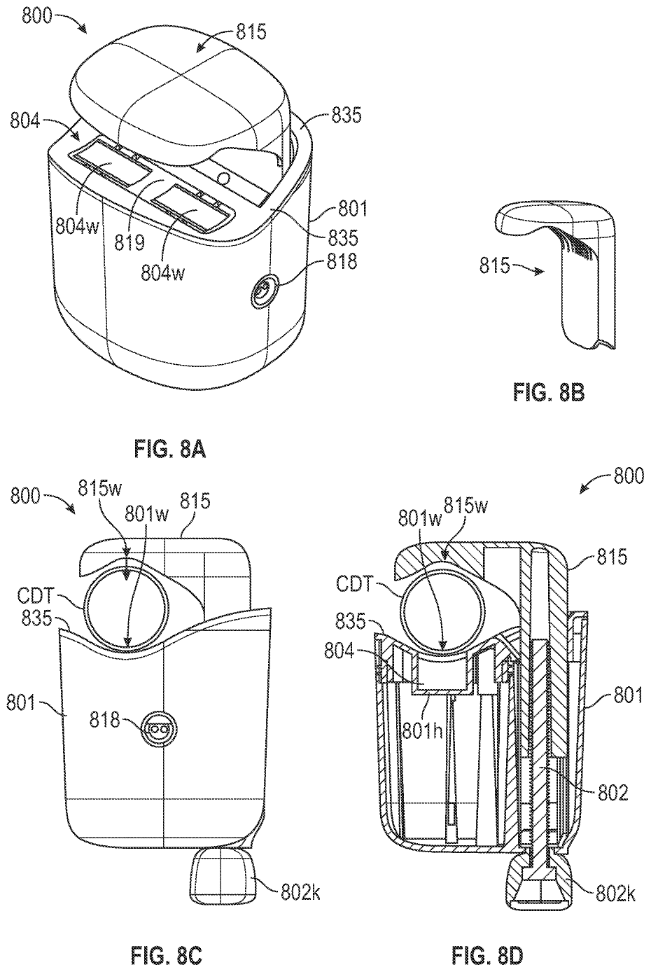

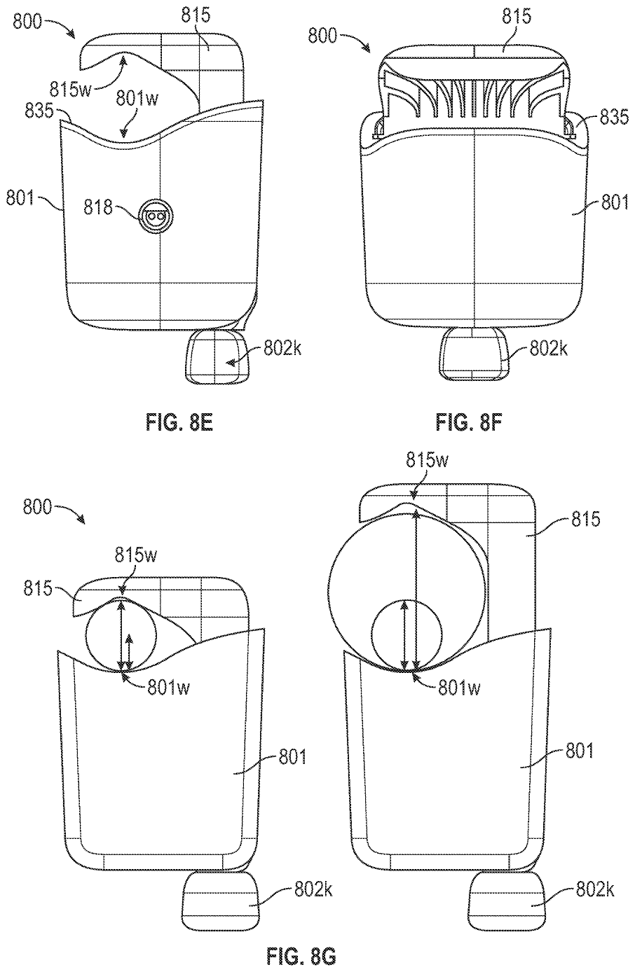

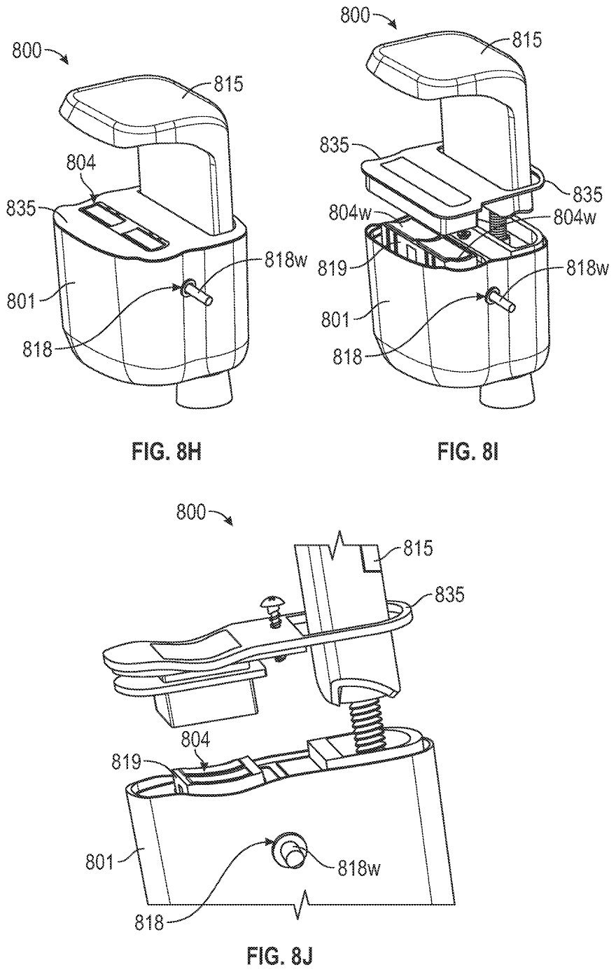

FIG. 8A provides a view of sensing assembly 800, according to an embodiment. Sensing assembly 800 comprises housing 801 having ultrasonic sensor assembly 804 positioned therein. Ultrasonic sensor assembly 804 comprises wedges 804w positioned in wedge holder 819. Housing 801 comprises electronic port 818, configured to receive a plug/electric wire to provide electric power to components including a controller (not visible), LED indicator (not visible), and sensor assembly 804. Sensing assembly 800 comprises cradle 815, shown separately in FIG. 8B. Cradle 815 is configured to receive and hold conduits of various diameters in physical contact with wedges 804w. Sensing assembly 800 also comprises light pipe 835, which encircles an entire perimeter of an upper edge of housing 801 (edge about the housing interior). Assembly 800 comprises a compact shape and size, allowing it to be coupled to conduits of various diameters in a variety of tight spaces. Light pipe 835 is configured to be visible from essentially any angle, indicating if/when assembly 800 is/has been properly installed on a conduit. Proper installation may be when a conduit is positioned on wedges 804w so that an optimal ultrasonic signal is received by a controller.

FIG. 8C shows a side view of sensing assembly 800, and FIG. 8D shows a cross-section view of sensing assembly 800, according to some embodiments. Conduit CDT is coupled to sensor assembly 804 in housing 801, and is positioned between housing 801 and cradle 815. Cradle 815 comprises well 815w configured to receive conduit CDT and housing 801 comprises well 801w also configured to receive conduit CDT. Cradle 815 is configured to be adjustably moved via screw 802 and knob 802k relative to housing 801, such that cradle well 815w and housing well 801w may be moved along a substantially straight line to and away from (relative to) each other to accommodate conduits of varying diameters. An interior of housing 801 comprises rectangular box-shaped opening 801h, configured to hold sensor assembly 804.

FIG. 8E and FIG. 8F provide further views of sensing assembly 800, according to some embodiments. Various dimensions are shown, for example in the position shown, housing 801 and knob 802k together comprise a longest dimension of about 100 mm, a width of about 85 mm, and a depth of about 70 mm. Accordingly, housing 801, including knob 802k, may have a total volume of about 600 cm³. It is seen that cradle well 815w and housing well 801w are substantially aligned, that is, each having low points substantially positioned on a same line, and configured to be adjustably moved relative to each other along a line. FIG. 8G shows sensing assembly 800 coupled to conduits having outer diameters (OD) of about 23 mm on the left, and about 51 mm on the right. The shorter double arrow on the left represents a minimum opening of about 15 mm. Assembly 800 is configured to receive and couple to conduits having minimum OD of about 15 mm (about 0.6 inches) to maximum OD of about 51 mm (about 2.0 inches). In sensing assembly 800, adjustment mechanism 802/802k is configured to “pull” cradle 815 towards sensor assembly 804, rather than “push” it towards a sensor assembly.

FIG. 8H, FIG. 8I, and FIG. 8J provide various views of sensing assembly 800, wherein light pipe 835 is visible. Also shown are ultrasonic sensor assembly 804, comprising wedges 804w positioned in wedge holder 819. Also shown is wire portion 818w plugged into electric port 818. Light pipe 835 is a separate part, configured to be positioned about an entire perimeter of an edge of housing 801. Light pipe 835 also functions as a lid positioned over sensor assembly 804. LED lights (not shown) may be mounted on a controller (not shown) positioned at an interior of housing 801. LED lights may be configured to for example flash yellow as assembly 800 is positioned on a conduit. As one adjusts assembly 802/802k to optimize a conduit position on sensor assembly 804 between cradle 815 and housing 801, and a good or optimal ultrasonic signal is detected by the controller, the one or more LED lights may be configured to emit a solid color, for example green. LED lights may be configured to emit light towards light pipe 835, and light may be configured to illuminate an entire or about an entire volume of light pipe 835. Light pipe 835 may be solid or have a hollow volume, and may be translucent. Light pipe 835 is configured to provide a view of LED lights from about any view or angle. In an embodiment, light pipe 835 may comprise a thermoplastic, for example an engineering thermoplastic, for instance polycarbonate.

A thermoplastic may include for example an engineering thermoplastic. In some embodiments, a wedge may comprise a thermoplastic selected from one or more of a polyamide, a polyester, a polycarbonate, a polyacetal, acrylonitrile-butadiene-styrene, poly(methyl (meth)acrylate), a polyetheretherketone, a polyetherketoneketone, a polyketone, a polyphenylene sulfide, a polyphenylene oxide, a polysulfone, or polytetrafluoroethylene. Polysulfones include for example one or more of poly(arylene sulfone), poly(bisphenol-A sulfone), polyether sulfone, polyphenhylenesulfone, polysulfone, or VICTREX HTA. Reference to “polysulfone” may mean one or more of the above-listed polysulfones.

In some embodiments, a thermoplastic chosen for fabrication of a wedge may have a speed of sound and/or an acoustic impedance about that of water. This may reduce undesirable effects of refraction of ultrasonic waves as they pass through different mediums. In some embodiments, fabrication of a wedge may be accomplished by molding techniques, for example injection molding. In some embodiments, fabrication of a wedge may be accomplished with 3D printing techniques.

An ultrasonic sensor assembly may comprise a first ultrasonic transducer coupled to a first upstream wedge, and a second ultrasonic transducer coupled to a second downstream wedge. A first wedge may be positioned on a conduit upstream portion, and a second wedge may be positioned on a conduit downstream portion. The upstream/downstream orientation of the wedges may be reversed as necessary for positioning of a sensing assembly on a material conduit. The first and second wedge assemblies may be symmetrical and interchangeable. When coupled to a conduit, the first and second wedges may be mirror images of each other. The wedges may be in direct physical contact with a material conduit at a wedge lateral contact surface.

An ultrasonic transducer may be coupled to a first upstream wedge upstream angled surface, and a second ultrasonic transducer may be coupled to a second downstream wedge downstream angled surface as shown in the figures. The wedge angled surfaces may be configured to optimize an angle at which an ultrasonic signal or wave is directed through a conduit and to the other ultrasonic transducer. Likewise, the opposing angled surfaces not having the ultrasonic transducers coupled thereto may also be configured to optimize an angle at which an ultrasonic signal or wave is directed through a conduit and to the other ultrasonic transducer.

In some embodiments, a sensing assembly may comprise a surface contact promoter, configured to be in contact with the first wedge, with the second wedge, and with the conduit. A surface contact promoter is configured to increase surface contact between a first wedge, a second wedge, and a conduit. In some embodiments, a surface contact promoter may comprise an elastomeric strip, for example a silicon strip. In some embodiments, a surface contact promoter may comprise a gel. A strip or a gel may comprise an adhesive. In some embodiments, a surface contact promoter may be in direct contact with each of a first and a second wedge and a conduit. In other embodiments, a surface contact promoter may comprise an elastomeric coating on a wedge contact surface. In some embodiments, a wedge having a surface contact promoter may still be considered to be in direct physical contact with a conduit.

An ultrasonic transducer may be a piezo transducer. Ultrasonic transducers may be in wired or wireless electronic communication with a controller (e.g. a microcontroller or microprocessor) and a power source. The ultrasonic transducers may be in wired or wireless communication with an analog-to-digital converter. In some embodiments, the ultrasonic transducers send and receive, on an alternating basis, ultrasonic waves through a first wedge, through a conduit having a material therein, and through a second wedge. The sonic data may be converted to an electrical signal, which is sent to an analog-to-digital converter. An analog-to-digital converter may convert an electrical signal to digital data. A controller may be configured to receive digital data from an analog-to-digital converter.

A controller may be configured to determine a time-of-flight (ToF) from sensed data. Based on a ToF measurement, a controller is configured to determine a material flow rate from an algorithm.

A controller may be configured to evaluate digital data. A controller may comprise an algorithm configured to recognize and identify water-use devices and appliances by their water-use “sound signature”. Water-use devices and appliances may include one or more of a toilet, a urinal, a faucet, a dishwasher, a washing machine, a shower, a tub spout, an ice-maker, a hot water heater, and the like, including other features having a water valve, for example a sprinkler system or an outdoor hose.

A controller may be configured to recognize a material temperature, for example, a sensing assembly may comprise one or more temperature sensors in electronic communication with a controller. A controller may comprise an algorithm configured to factor a material temperature into account (compensate for) when determining a material flow rate. In some embodiments, the material temperature may be continuously monitored by a controller. In some embodiments, a material temperature may be determined from monitoring a relative speed of sonic waves through a material.

A controller may be configured to recognize and determine a plumbing system normal and abnormal state. For example, a plumbing system normal state recognition may include determination of “no leak”. A plumbing system abnormal state recognition may include determination of a water leak. A water leak may be a general leak somewhere in a conduit, and/or may be a leak associated with a certain water-use device or appliance. A leak might include a running toilet because a flapper is not properly seated on a valve. In some embodiments, a sensing assembly may be configured to recognize and determine a general leak and/or a leak associated with a specific (individual) water-use device or appliance.

A controller may be configured to report a plumbing system normal or abnormal state. For example, a computing device, such as a smartphone or a laptop computer, may be linked to a controller. A controller may be configured to transmit data to a computing device. A computing device may have a graphical user interface configured to display data, including water-use device and appliance water use data, water efficiency data, efficiency data over time, etc.

In some embodiments, a material conduit may be a water pipe, for example may be a main water-source pipe for a residence or may be a main water-source pipe for a portion of a large apartment building or office building. In some embodiments, a sensing assembly may be configured to be positioned on a conduit with an adjustment mechanism or device, for example a clamp device, a screw, a set screw, a spring, and the like. A sensing assembly may be coupled to conduits of different sizes, for example having diameters of from about 0.5 inches to about 1.5 inches or more. Diameter may refer to inner or outer conduit diameter. A sensing assembly may be configured for use on conduits of different materials, for example copper, iron, steel, PVC, or PEX (cross-linked polyethylene).

In some embodiments, a sensing assembly may be coupled to both of an incoming cold water pipe and an incoming hot water pipe. For example, an incoming hot water pipe may be downstream of a hot water heater.

In other embodiments, a material conduit may be a gas pipe, for instance a conduit used to carry natural gas. In some embodiments, a material conduit may be a pipe configured to transport crude oil, refine oil, or gasoline. Conduits may include pipes configured to carry or transport a material including one or more of a gas, a liquid (free-flowing or a viscous liquid), a particulate, a liquid suspension, a liquid solution, etc. In some embodiments, material may include refrigerants, for instance refrigerants employed in HVAC systems.

In some embodiments, a controller may be electrically coupled with an indicator or display configured to indicate if a sensing assembly in positioned on a conduit in a suitable position to receive sensed information. For example, a controller may be in electronic communication with indicator LED lights. For example, an LED light indicator may show red for no signal, yellow for weak signal, and green for good (optimal) signal), and may guide an installer as to proper positioning of an adjustment mechanism.

In some embodiments, a conduit diameter may be necessary information for a controller to be able to determine a material flow rate. A conduit diameter may be measured with a “ruler” and the data input to a controller. In some embodiments, a sensing assembly may comprise a proximity sensor configured to determine a position of an adjustment mechanism. A proximity sensor, electrically coupled to a controller, is configured to relay an adjustment mechanism position to a controller, and the controller is configured to determine a conduit diameter from the sensed position. Proximity sensors may comprise one or more inductive, capacitive, optical (infrared (IR), photoelectric), magnetic, ultrasonic, or rotary sensors.

In some embodiments, a sensing system may be configured to be easily coupled to a conduit in a variety of orientations without the use of any tool. In some embodiments, a sensing system may be “one piece”, meaning the part positioned on the conduit may be a single part that may simply be coupled to a conduit.

In some embodiments, a sensing system may comprise a housing and an adjustment mechanism. An ultrasonic sensor may be positioned in a housing. A housing may have an opening through which a conduit may be coupled to an ultrasonic sensor. A housing opening may have angled or curved edges adjacent to the opening, configured for the assembly to receive conduits having different diameters.

In some embodiments, a first ultrasonic transducer may be coupled to an upstream surface of a first upstream wedge, and a second ultrasonic transducer may be coupled to a downstream surface of a second downstream wedge.

In some embodiments, an ultrasonic transducer may be coupled to an angled surface of a wedge. An angled surface may be defined by an angle between a wedge lateral contact surface and the angled surface. In some embodiments this angle may be from any of about 40°, about 42°, about 44°, about 46°, about 48°, about 50°, about 52°, about 54°, or about 56°, to any of about 58°, about 60°, about 62°, about 64°, about 66°, about 68°, about 70°, about 72°, about 74°, about 76°, or more.

In some embodiments, a wedge may comprise a length of from any of about 10 mm, about 12 mm, about 14 mm, about 16 mm, or about 18 mm, to any of about 20 mm, about 22 mm, about 23 mm, about 24 mm, about 25 mm, about 26 mm, about 27 mm, about 28 mm, about 30 mm, about 32 mm, about 34 mm, about 36 mm, about 40 mm, about 42 mm, about 44 mm, or more.

In some embodiments, a wedge may comprise a height of from any of about 6 mm, about 8 mm, about 10 mm, or about 11 mm, to any of about 12 mm, about 13 mm, about 14 mm, about 15 mm, about 17 mm, about 19 mm, about 21 mm, about 23 mm, about 25 mm, about 27 mm, about 29 mm, or more.

In some embodiments, a wedge may comprise a curved lateral contact surface, configured to provide for contact with conduits of various sizes (diameters). A curved lateral surface may be configured to be in direct physical contact with a conduit. Alternatively, as discussed above, a curved lateral surface may be in direct physical contact with a surface contact promoter, and the surface contact promoter may be in direct physical contact with a conduit. In some embodiments, a lateral contact surface may comprise a width of from any of about 4.0 mm, about 5.0 mm, about 6.0 mm, about 7.0 mm, or about 8.0 mm, to any of about 9.0 mm, about 10.0 mm, about 11.0 mm, about 12.0 mm, about 13.0 mm, about 14.0 mm, about 15.0 mm, about 16.0 mm, or more.

In some embodiments, a wedge contact surface may have a lateral trough positioned on either side. A wedge contact surface and the lateral troughs may be substantially parallel with each other. A lateral trough positioned alongside a contact surface may help prevent an ultrasonic sensor from detecting ultrasonic waves that are not aligned with a conduit centerline. In some embodiments, a lateral trough may comprise a width of from any of about 0.3 mm, about 0.5 mm, about 0.7 mm, about 0.9 mm, about 1.1 mm, or about 1.3 mm, to any of about 1.5 mm, about 1.7 mm, about 1.9 mm, about 2.1 mm, about 2.3 mm, about 2.5 mm, about 2.7 mm, or more. In some embodiments, a lateral trough may comprise a depth of from any of about 0.4 mm, about 0.6 mm, about 0.8 mm, or about 1.0 mm, to any of about 1.2 mm, about 1.4 mm, about 1.6 mm, about 1.8 mm, about 2.0 mm, about 2.2 mm, about 2.4 mm, about 2.6 mm, about 2.8 mm, about 3.0 mm, or more.

In some embodiments a first wedge may comprise a downstream angled surface and a second wedge may comprise an upstream angled surface, which angled surfaces are substantially mirror images of each other.

In some embodiments, a wedge may comprise a channel or trough positioned on an upper portion thereof. A channel positioned on an upper portion may be substantially perpendicular to a lateral contact surface and lateral troughs adjacent the lateral contact surface. Such a channel may be configured to provide for adjustment or movement of a sensor assembly to aid in alignment with a conduit.

In some embodiments, an ultrasonic transducer may be directly bonded to a wedge surface. This may be accomplished with an adhesive, ultrasonic welding, etc. Adhesives may include epoxy, acrylic, etc.

In some implementations, an adjustment mechanism may be configured to adjust, or adjustably move, a cradle towards and away from an ultrasonic sensor assembly positioned in a housing interior. An adjustable movement of a cradle towards and away from an ultrasonic sensor assembly is configured to place a sensing assembly in an optimal position on a conduit. When a sensing assembly is properly positioned on a conduit, a cradle may aid in holding and maintaining the proper position. In some embodiments, an adjustment mechanism may be configured to “push” a cradle configured to receive a conduit towards a housing and ultrasonic sensor assembly, as illustrated in FIGS. 4A-4E, or alternatively, may be configured to “pull” a cradle towards a housing and ultrasonic sensor assembly, as illustrated in FIGS. 8A-8G.

In some embodiments, a housing having an ultrasonic sensor assembly positioned therein, may comprise a first well, or curved portion, configured to receive a conduit and to aid in positioning the conduit on wedges of the ultrasonic sensor assembly. In some embodiments, a cradle may comprise a second well, or curved portion also configured to receive a conduit, and to aid in positioning the conduit on the ultrasonic sensor assembly as the conduit is coupled to the sensing assembly. A first well and a second well may be configured to be adjustably moved relative to each other in order to couple a conduit to a sensing assembly. Such adjustable movement may be linear. A first well and a second well each comprise a “low point”, that is, a deepest point along a curved well portion. In some embodiments, a first well low point and a second well low point may be positioned on a straight line, and configured to be adjustably moved towards and away from each other along the straight line.

In some embodiments, a housing may comprise a rectangular box-like portion configured to receive an ultrasonic sensor assembly. In some embodiments, a housing may comprise a compact shape, allowing it to be positioned on a conduit in a “tight” space, for example a conduit positioned close to a wall or walls. In some embodiments, a housing, together with any knob portion of an adjustment mechanism, may have a longest dimension of from any of about 70 mm, about 80 mm, or about 90 mm, to any of about 100 mm, about 110 mm, about 120 mm, or about 130 mm. In some embodiments, a housing may have a width of from any of about 60 mm, about 65 mm, about 70 mm, or about 75 mm, to any of about 80 mm, about 85 mm, about 90 mm, about 95 mm, about 100 mm, or about 110 mm. In some embodiments, a housing may comprise a depth of from any of about 45 mm, about 50 mm, about 55 mm, or about 60 mm, to any of about 65 mm, about 70 mm, about 75 mm, about 80 mm, about 85 mm, about 90 mm, or about 95 mm. An overall space, or volume, that a housing may occupy may for example be from any of about 400 cm³, about 450 cm³, about 500 cm³, about 550 cm³, or about 600 cm³, to any of about 650 cm³, about 700 cm³, about 750 cm³, or about 800 cm³.

In some implementations, a sensing assembly may be configured to be adjustably and optimally positioned on, or coupled to, conduits having an outer diameter (OD) of from any of about 15 mm, about 18 mm, about 21 mm, about 24 mm, about 27 mm, about 30 mm, or about 33 mm, to any of about 36 mm, about 39 mm, about 42 mm, about 45 mm, about 48 mm, or about 51 mm.

In some embodiments, a controller may be positioned at a housing interior. A controller may be electrically coupled to an ultrasonic sensor assembly, and may also be electrically coupled to one or more LED indicator lights. One or more LED indicator lights may be configured to indicate a strength of an ultrasonic signal received by the controller from an ultrasonic sensor. For example, an LED indicator light may be configured to indicate to a user if and when a sensing assembly is properly coupled to a conduit such as an optimal ultrasonic signal is received by the controller. For example, an LED indicator light may display or flash a first color as a sensing assembly is being coupled to a conduit, and display or flash a second color when the assembly is properly installed. An LED indicator light may be configured to emit a first or a second color based on instructions from the controller.

In some embodiments, one or more LED indicator lights may be positioned at a housing exterior and visible to an installer. In other embodiments, one or more LED indicator lights may be positioned at a housing interior, and configured to emit light from a housing interior towards a conduit and/or towards a cradle. In some embodiments, a housing may comprise a light pipe positioned at least partially about a housing edge, which edge is positioned about a housing interior. A light pipe may be positioned about an entire perimeter of a housing edge. One or more LED lights positioned at a housing interior, may be configured to emit light from the housing interior towards the light pipe, so that the light pipe will be illuminated. In this way, the indicator light may be visible from any angle or about any angle or vantage point.

In some embodiments, a light pipe may comprise a portion configured to cover a housing interior. In some cases, a light pipe may comprise a portion configured to function as a lid to position an ultrasonic sensor assembly in the housing interior. In some embodiments, one or more LED lights may be configured to illuminate an entire volume of a light pipe. A light pipe may comprise a translucent thermoplastic, for example polycarbonate. A light pipe may be a solid unitary part, or may comprise a hollow portion.

Following are some non-limiting embodiments of the disclosure.

In a first embodiment, disclosed is a sensing assembly configured to monitor material flow in a conduit, the sensing assembly comprising an adjustment mechanism; a housing; and an ultrasonic sensor assembly, wherein the ultrasonic sensor assembly is at least partially positioned within the housing and comprises an ultrasonic sensor, the ultrasonic sensor is configured to couple a conduit, and the adjustment mechanism is configured to allow for coupling of the ultrasonic sensor to conduits having a variety of diameters.

In a second embodiment, disclosed is a sensing assembly according to embodiment 1, wherein the material comprises a gas, a liquid, a solution, a suspension, or a particulate. In a third embodiment, disclosed is a sensing assembly according to embodiments 1 or 2, wherein the material comprises water, natural gas, oil, or gasoline. In a fourth embodiment, disclosed is a sensing assembly according to any of the preceding embodiments, wherein the material comprises water.

In a fifth embodiment, disclosed is a sensing assembly according to embodiment 1, wherein the adjustment mechanism comprises an adjustment screw or a spring. In a sixth embodiment, disclosed is a sensing assembly according to any of the preceding embodiments, wherein the sensing assembly is one-piece. In a seventh embodiment, disclosed is a sensing assembly according to any of the preceding embodiments, wherein coupling of the ultrasonic sensor to a conduit requires no tools. In an eighth embodiment, disclosed is a sensing assembly according to any of the preceding embodiments, wherein the housing comprising angled or curved edges adjacent the housing opening.

In a ninth embodiment, disclosed is a sensing assembly according to any of the preceding embodiments, wherein the ultrasonic sensor comprises a first ultrasonic transducer coupled to a first upstream wedge and a second ultrasonic transducer coupled to a second downstream wedge, wherein the first wedge and the second wedge are configured to be in direct physical contact with a conduit through a wedge lateral contact surface, and wherein the first wedge and the second wedge are symmetrical and interchangeable.

In a tenth embodiment, disclosed is a sensing assembly according to embodiment 9, wherein the first wedge lateral contact surface and the second wedge lateral contact surface are in direct contact with a surface contact promoter, and wherein the surface contact promoter is configured to be in direct contact with a conduit. In an eleventh embodiment, disclosed is a sensing assembly according to embodiments 9 or 10, wherein the first upstream wedge and the second downstream wedge are mirror images of each other. In a twelfth embodiment, disclosed is a sensing assembly according to any of embodiments 9 to 11, wherein the first ultrasonic transducer and the second ultrasonic transducer are configured to alternately send and receive an ultrasonic signal through the first wedge, through a conduit, and through the second wedge.

In a thirteenth embodiment, disclosed is a sensing assembly according to any of embodiments 9 to 12, wherein the first wedge and the second wedge comprise an engineering thermoplastic. In a fourteenth embodiment, disclosed is a sensing assembly according to any of embodiments 9 to 13, wherein the first wedge and the second wedge comprise one or more of polyamide, a polyester, a polycarbonate, a polyacetal, acrylonitrile-butadiene-styrene, poly(methyl (meth)acrylate), a polyetheretherketone, a polyetherketoneketone, a polyketone, a polyphenylene sulfide, a polyphenylene oxide, a polysulfone, or polytetrafluoroethylene. In a fifteenth embodiment, disclosed is a sensing assembly according to any of embodiments 9 to 14, wherein the first wedge and the second wedge comprise a thermoplastic having a speed of sound and/or an acoustic impedance about equal to that of water.

In a sixteenth embodiment, disclosed is a sensing assembly according to any of embodiments 9 to 15, wherein the first ultrasonic transducer is coupled to an upstream surface of the first upstream wedge and the second ultrasonic transducer is coupled to a downstream surface of the second downstream wedge. In a seventeenth embodiment, disclosed is a sensing assembly according to embodiment 16, wherein the first ultrasonic transducer is coupled to an upstream angled surface of the first wedge and the second ultrasonic transducer is coupled to a downstream angled surface of the second wedge, wherein the angled surface is defined by an angle between the wedge lateral contact surface and the angled surface. In an eighteenth embodiment, disclosed is a sensing assembly according to embodiment 17, wherein the angle between the wedge lateral contact surface and the angled surface is from about 40° to about 75°.

In a nineteenth embodiment, disclosed is a sensing assembly according to any of embodiments 9 to 18, wherein first upstream wedge and the second downstream wedge comprise a length of from about 13 mm to about 40 mm and a height of from about 7 mm to about 27 mm. In a twentieth embodiment, disclosed is a sensing assembly according to any of embodiments 9 to 19, wherein the first wedge and the second wedge comprise a curved lateral contact surface configured to receive conduits having a variety of diameters. In a twenty-first embodiment, disclosed is a sensing assembly according to any of embodiments 9 to 20, wherein the wedge lateral contact surface comprises a width of from about 5.0 mm to about 15.0 mm.

In a twenty-second embodiment, disclosed is a sensing assembly according to any of embodiments 9 to 21, wherein the first wedge and the second wedge comprise a lateral trough positioned on either side of the wedge contact surface and parallel with each other. In a twenty-third embodiment, disclosed is a sensing assembly according to embodiment 22, wherein the lateral trough comprises a width of from about 0.3 mm to about 2.5 mm, and a depth of from about 0.5 mm to about 3.0 mm.

In a twenty-fourth embodiment, disclosed is a sensing assembly according to any of embodiments 9 to 23, wherein the first wedge comprises a downstream angled surface, and the second wedge comprises a mirror image upstream angled surface. In a twenty-fifth embodiment, disclosed is a sensing assembly according to any of embodiments 9 to 24, wherein the first wedge and the second wedge comprise a channel positioned on an upper portion thereof, and wherein the channel is perpendicular to the lateral contact surface.

In a twenty-sixth embodiment, disclosed is a sensing assembly according to any embodiments 9 to 25, wherein the ultrasonic sensor assembly comprises a wedge holder configured to receive and couple to the first wedge and the second wedge. In a twenty-seventh embodiment, disclosed is a sensing assembly according to embodiment 26, wherein the wedge holder comprises brackets configured to receive the first wedge and the second wedge. In a twenty-eighth embodiment, disclosed is a sensing assembly according to embodiments 26 or 27, wherein the wedge holder comprises one or more protrusions and the first wedge and the second wedge comprise one or more holes or indentations, or visa-versa, wherein the one or more protrusions are configured to couple to the one or more holes or indentations, and wherein the one or more protrusion/hole or indentation couplings are configured to provide for a degree of freedom of movement/rotation of the first wedge and the second wedge to optimize contact with a conduit.

In a twenty-ninth embodiment, disclosed is a sensing assembly according to any of embodiments 9 to 28, wherein the first ultrasonic transducer and the second ultrasonic transducer are bonded to the first wedge and to the second wedge, respectively, with an adhesive. In a thirtieth embodiment, disclosed is a sensing assembly according to any of embodiments 9 to 29, wherein the first ultrasonic transducer and the second ultrasonic transducer are electrically coupled to a controller. In a thirty-first embodiment, disclosed is a sensing assembly according to any of embodiments 12 to 30, wherein the controller is configured to determine a time-of-flight (ToF) of the ultrasonic signal, and the controller is configured to determine a material flow rate in the conduit based on the ToF.

In a thirty-second embodiment, disclosed is a sensing assembly according to any of embodiments 12 to 31, wherein the ultrasonic sensor is electrically coupled to a controller, the controller is electrically coupled to an indicator, and based on instructions from the controller, the indicator is configured to indicate a strength of the ultrasonic signal. In a thirty-third embodiment, disclosed is a sensing assembly according to embodiment 32, wherein the indicator comprises one or more LED lights.

In a thirty-fourth embodiment, disclosed is a sensing assembly according to any of the preceding embodiments, further comprising one or more sensors configured to determine a conduit diameter. In a thirty-fifth embodiment, disclosed is a sensing assembly according to embodiment 34, wherein the one or more further sensors are selected from inductive, capacitive, optical (infrared (IR), photoelectric), magnetic, ultrasonic, or rotary sensors. In a thirty-sixth embodiment, disclosed is a sensing assembly according to any of the preceding embodiments, further comprising a temperature sensor.

In a thirty-seventh embodiment, disclosed is a sensing assembly according to any of embodiments 9 to 36, comprising more than one pair of first upstream/second downstream wedges, and wherein the controller is configured to determine which pair to receive data from, depending on which pair provides a stronger ultrasonic signal.

In a thirty-eighth embodiment, disclosed is a sensing assembly according to any of embodiments 9 to 37, configured to automatically adjust a lateral distance between a first upstream wedge and a second downstream wedge, wherein an optimal ultrasonic signal is determinative of an optimal lateral distance.

In a thirty-ninth embodiment, disclosed is a sensing assembly according to any of embodiments 9 to 38, wherein the adjustment mechanism is configured to provide for an optimal coupling position of the sensing assembly to a conduit, and wherein an optimal ultrasonic signal is determinative of an optimal coupling position. In a fortieth embodiment, disclosed is a sensing assembly according to embodiment 39, wherein the optimal coupling position comprises an optimal coupling force. In a forty-first embodiment, disclosed is a sensing assembly according to embodiments 39 or 40 wherein the optimal coupling position comprises an optimal contact of a conduit with the first upstream wedge and the second downstream wedge. In a forty-second embodiment, disclosed is a sensing assembly according to any of embodiments 39 to 41, wherein the optimal coupling position comprises a lateral distance between the first upstream wedge and the second downstream wedge along a conduit. In a forty-third embodiment, disclosed is a sensing assembly according to any of embodiments 38 to 42, wherein the adjustment mechanism is configured to manually adjust a lateral distance between a first upstream wedge and a second downstream wedge.

In a forty-fourth embodiment, disclosed is a sensing assembly according to any of the preceding embodiments, wherein the assembly is configured to recognize water flow associated with an individual water-use device or appliance, from a plurality of devices or appliances. In a forty-fifth embodiment, disclosed is a sensing assembly according to embodiment 44, wherein the water-use device or appliance is one or more of a toilet, a urinal, a faucet, a valve, a dishwasher, a washing machine, a shower, a tub spout, or an ice-maker. In a forty-sixth embodiment, disclosed is a sensing assembly according to embodiments 44 or 45, wherein the sensing assembly is configured to determine and report a normal state or an abnormal state of a water-use device or appliance. In a forty-seventh embodiment, disclosed is a sensing assembly according to any of the preceding embodiments, wherein the assembly is configured to determine a plumbing system normal state or an abnormal state not associated with an individual water-use device or appliance.

In a forty-eighth embodiment, disclosed is a sensing assembly according to any of the preceding embodiments, wherein the conduit is a main water supply pipe of a building. In a forty-ninth embodiment, disclosed is a sensing assembly according to any of the preceding embodiments, wherein the conduit comprises a diameter of from about 0.5 inches to about 1.0 inches. In a fiftieth embodiment, disclosed is a sensing assembly according to any of the preceding embodiments, wherein the conduit comprises a metal or a plastic. In a fifty-first embodiment, disclosed is a sensing assembly according to any of the preceding embodiments, wherein the conduit comprises copper, steel, PVC, or PEX.

In a fifty-second embodiment, disclosed is a sensing assembly according to any of the preceding embodiments, wherein the adjustment mechanism is configured to adjust a position of a cradle configured to receive the conduit. In a fifty-third embodiment, disclosed is a sensing assembly according to any of the preceding embodiments, wherein the adjustment mechanism is configured to adjust a position of a cradle configured to receive the conduit, the cradle position is adjustable relative to the housing and the ultrasonic sensor assembly, and the cradle is configured to hold the conduit in position on the ultrasonic sensor assembly. In a fifty-fourth embodiment, disclosed is a sensing assembly according to embodiments 52 or 53, wherein the adjustment mechanism is configured to adjustably push the cradle towards the housing and ultrasonic sensor assembly. In a fifty-fifth embodiment, disclosed is a sensing assembly according to embodiments 52 or 53, wherein the adjustment mechanism is configured to adjustably pull the cradle towards the housing and ultrasonic sensor assembly.

In a fifty-sixth embodiment, disclosed is a sensing assembly according to any of the preceding embodiments, wherein the housing comprises a first well configured to receive the conduit and to aid in positioning the conduit on the ultrasonic sensor assembly. In a fifty-seventh embodiment, disclosed is a sensing assembly according to any of embodiments 52 to 56, wherein the cradle comprises a second well configured to receive the conduit and to aid in positioning the conduit on the ultrasonic sensor assembly. In a fifty-eighth embodiment, disclosed is a sensing assembly according to embodiment 57, wherein the first well and the second well are configured to adjustably move relative to each other in a linear fashion. In a fifty-ninth embodiment, disclosed is a sensing assembly according to embodiments 57 or 58, wherein the first well comprises a first well low point, and the second well comprises a second well low point, and wherein the first well low point and the second well low point are positioned on a straight line, and are configured to adjustably move relative to each other along the straight line.

In a sixtieth embodiment, disclosed is a sensing assembly according to any of the preceding embodiments, wherein an interior of the housing comprises a rectangular box-like shaped opening configured to receive the ultrasonic sensor assembly. In a sixty-first embodiment, disclosed is a sensing assembly according to any of the preceding embodiments, wherein the housing comprises an overall volume of from about 400 cm³ to about 800 cm³.

In a sixty-second embodiment, disclosed is a sensing assembly according to any of the preceding embodiments, wherein the sensing assembly is configured to couple to conduits having an outer diameter of from about 15 mm to about 51 mm.

In a sixty-third embodiment, disclosed is a sensing assembly according to any of the preceding embodiments, comprising a controller positioned at a housing interior, wherein the controller is electrically coupled to the ultrasonic sensor assembly, the controller is electrically coupled to one or more LED indicator lights, and based on instructions from the controller, the one or more LED indicator lights are configured to indicate a strength of the ultrasonic signal. In a sixty-fourth embodiment, disclosed is a sensing assembly according to embodiment 63, wherein the one or more LED indicator lights are configured to emit light from the housing interior towards the cradle. In a sixty-fifth embodiment, disclosed is a sensing assembly according to embodiments 63 or 64, wherein the housing comprises a light pipe positioned at least partially about a housing edge positioned about the housing interior, the light pipe is configured to be illuminated by the one or more LED indicator lights, and the illuminated light pipe is configured to be visible from various angles.

In a sixty-sixth embodiment, disclosed is a sensing assembly according to embodiment 65, wherein the light pipe comprises a portion configured to function as a lid to position the ultrasonic sensor assembly in the housing interior. In a sixty-seventh embodiment, disclosed is a sensing assembly according to embodiments 65 or 66, wherein the light pipe is positioned about an entire perimeter of the housing edge. In a sixty-eighth embodiment, disclosed is a sensing assembly according to any of embodiments 65 to 67, wherein the one or more LED lights are configured to illuminate at least part of an entire volume of the light pipe. In a sixty-ninth embodiment, disclosed is a sensing assembly according to any of embodiments 65 to 68, wherein the one or more LED lights are configured to illuminate an entire volume of the light pipe.

In a seventieth embodiment, disclosed is a sensing assembly according to any of the preceding embodiments, wherein the assembly is configured to monitor a material temperature, and the controller is configured to adjust a determination of a material flow rate depending on the material temperature.

In a seventy-first embodiment, disclosed is a sensing assembly according to any of the preceding embodiments, wherein the assembly is configured to determine a water leak or failure of an individual water-use device or appliance. In a seventy-second embodiment, disclosed is a sensing assembly according to embodiment 71, wherein the assembly is configured to report the water leak or failure.

In a seventy-third embodiment, disclosed is an ultrasonic sensor assembly according to any of the preceding embodiments.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other.

The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, about ±5%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, or ±10% of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A sensing assembly configured to monitor material flow in a conduit, the sensing assembly comprising
an adjustment mechanism;
a controller;
a housing; and
an ultrasonic sensor assembly,
wherein
the ultrasonic sensor assembly is at least partially positioned at a housing interior and comprises an ultrasonic sensor,
the ultrasonic sensor is configured to couple to a conduit,
the adjustment mechanism is configured to allow for coupling of the ultrasonic sensor to conduits having a variety of diameters,
the ultrasonic sensor comprises a first ultrasonic transducer coupled to a first upstream wedge and a second ultrasonic transducer coupled to a second downstream wedge, and
the first ultrasonic transducer and the second ultrasonic transducer are electrically coupled to the controller.

2. The sensing assembly according to claim 1, wherein the conduit is a main water supply pipe of a building or a residence, the material is water, and the assembly is configured to recognize and report water flow associated with an individual water-use device or appliance selected from one or more of a toilet, a urinal, a faucet, a valve, a dishwasher, a washing machine, a shower, a tub spout, or an ice-maker.

3. The sensing assembly according to claim 2, wherein the sensing assembly is configured to determine and report a normal state or an abnormal state of the water-use device or appliance.

4. The sensing assembly according to claim 2, wherein the assembly is configured to determine a plumbing system normal state or an abnormal state not associated with an individual water-use device or appliance.

5. The sensing assembly according to claim 1, wherein the sensing assembly is configured to couple to conduits having an outer diameter of from about 15 mm to about 51 mm.

6. The sensing assembly according to claim 1, wherein
the adjustment mechanism is configured to adjust a position of a cradle configured to receive the conduit,
the cradle position is adjustable relative to the housing and the ultrasonic sensor assembly,
the cradle is configured to hold the conduit in position on the ultrasonic sensor assembly, and
the adjustment mechanism is configured to adjustably push the cradle towards the housing and ultrasonic sensor assembly, or
the adjustment mechanism is configured to adjustably pull the cradle towards the housing and ultrasonic sensor assembly.

7. The sensing assembly according to claim 1, wherein
the controller is configured to determine a time-of-flight (ToF) of an ultrasonic signal,
the controller is configured to determine a material flow rate in the conduit based on the ToF,
the controller is electrically coupled to one or more LED indicator lights, and
based on instructions from the controller, the one or more LED indicator lights are configured to indicate a strength of the ultrasonic signal and an optimal coupling position of the sensing assembly to the conduit.

8. The sensing assembly according to claim 7, wherein
the housing comprises a light pipe positioned at least partially about a housing edge positioned about the housing interior,
the light pipe is configured to be illuminated by the one or more LED indicator lights,
the one or more LED indicator lights are configured to emit light from the housing interior towards the cradle,
the illuminated light pipe is configured to be visible from various angles, and
the one or more LED lights are configured to illuminate at least part of an entire volume of the light pipe.

9. The sensing assembly according to claim 8, wherein the light pipe comprises a portion configured to function as a lid to position the ultrasonic sensor assembly in the housing interior, and wherein the light pipe is positioned about an entire perimeter of the housing edge.

10. The sensing assembly according to claim 1, wherein
the first wedge and the second wedge comprise a curved lateral contact surface configured to receive conduits having a variety of diameters,
the first wedge lateral contact surface and the second wedge lateral contact surface are configured to be in direct physical contact with the conduit, or
the first wedge lateral contact surface and the second wedge lateral contact surface are in direct contact with a surface contact promoter, and the surface contact promoter is configured to be in direct contact with the conduit, and
the curved lateral contact surface has a width of from about 5.0 mm to about 15.0 mm.

11. The sensing assembly according to claim 1, wherein the first ultrasonic transducer and the second ultrasonic transducer are configured to alternately send and receive an ultrasonic signal through the first wedge, through a conduit, and through the second wedge.

12. The sensing assembly according to claim 1, wherein the first wedge and the second wedge comprise a thermoplastic having a speed of sound and/or an acoustic impedance about equal to that of water.

13. The sensing assembly according to claim 10, wherein
the first ultrasonic transducer is coupled to an upstream angled surface of the first wedge,
the second ultrasonic transducer is coupled to a downstream angled surface of the second wedge, and
the angled surface is defined by an angle between the wedge lateral contact surface and
the angled surface.

14. The sensing assembly according to claim 1, wherein the ultrasonic sensor assembly comprises a wedge holder configured to receive and couple to the first wedge and the second wedge, and the housing comprises an opening configured to receive the ultrasonic sensor assembly.

15. The sensing assembly according to claim 14, wherein the wedge holder comprises brackets configured to receive the first wedge and the second wedge.

16. The sensing assembly according to claim 14, wherein
the wedge holder comprises one or more protrusions and the first wedge and the second wedge comprise one or more holes or indentations, or
the wedge holder comprises one or more holes or indentations and the first wedge and the second wedge comprise one or more protrusions,
the one or more protrusions are configured to couple to the one or more holes or indentations, and
the one or more protrusion/hole or indentation couplings are configured to provide for a degree of freedom of movement of the first wedge and the second wedge so as to optimize contact with the conduit.

17. The sensing assembly according to claim 6, wherein
the housing comprises a first well, the cradle comprises a second well,
the first well and the second well are configured to receive the conduit and to aid in positioning the conduit on the ultrasonic sensor assembly,
the first well comprises a first well low point, the second well comprises a second well low point, and
the first well low point and the second well low point are positioned on a straight line, and are configured to adjustably move relative to each other along the straight line.

18. The sensing assembly according to claim 1, wherein the housing comprises an overall volume of from about 400 cm³ to about 800 cm³.

19. The sensing assembly according to claim 1, wherein the assembly is configured to monitor a material temperature, and the controller is configured to adjust a determination of a material flow rate depending on the material temperature.

20. The sensing assembly according to claim 1, wherein the assembly is configured to determine a conduit diameter, and the controller is configured to adjust a determination of a material flow rate depending on the conduit diameter.
